(19) United States
(12) Patent Application Publication
(10) Pub. No.: US 2006/0051731 A1
(43) Pub. Date: Mar. 9, 2006

(54) Processes for preparing lyophilized platelets

(76) Inventors: David Ho, Fairfax, VA (US); Joshua Dee, Germantown, MD (US); Cindy S. Orser, McLean, VA (US); Alan S. Rudolph, Potomac, MD (US)

Correspondence Address: MOAZZAM LATIMER LLP, 1474 NORTH POINT VILLAGE CENTER #320, RESTON, VA, 20194-1190, US

(21) Appl. No.: 11/197,310

(22) Filed: Aug. 5, 2005

Related U.S. Application Data
(60) Provisional application No. 60/600,838, filed on Aug. 12, 2004.
(60) Provisional application No. 60/619,930, filed on Oct. 20, 2004.
(60) Provisional application No. 60/671,063, filed on Apr. 14, 2005.

(51) Int. Cl. A01N 1/02

(52) U.S. Cl. 435/2

(57) ABSTRACT

The present invention provides processes for preparing freeze-dried platelets, freeze-dried platelets made by those processes, platelets reconstituted from those freeze-dried platelets, and kits comprising those freeze-dried platelets. The freeze-dried platelets of the invention have similar characteristics to fresh platelets, have an exceptionally long shelf-life, and can be used for all standard procedures in which fresh platelets are used, including both in vitro diagnostic and research procedures and in vivo therapies.

### CROSS-REFERENCE TO RELATED APPLICATIONS

The present application claims the benefit of the filing dates of U.S. Provisional patent application 60/600,838, filed 12 Aug. 2004; U.S. Provisional patent application 60/619,930, filed 20 Oct. 2004; U.S. Provisional patent application 60/671,063, filed 14 Apr. 2005; and U.S. patent application Ser. No. 11/152,774, filed 15 Jun. 2005; the disclosures of all of which are incorporated herein in their entireties by reference.

### BACKGROUND OF THE INVENTION

1. Field of the Invention

The present invention relates to the field of blood products. More specifically, the present invention relates to methods of making freeze-dried or lyophilized platelets for research and therapeutic purposes.

2. Description of Related Art

Platelets are components of the blood that are critical for maintenance of hemostasis. In particular, platelets are critical for clot formation, and thus for wound healing and proper maintenance of blood vessels. Platelets are formed in the bone marrow as fragments of megakaryocytes. They are irregularly-shaped, colorless bodies that are present in blood at a concentration of 150,000-450,000 per microliter (ul). When bleeding from a wound suddenly occurs, the platelets gather at the wound and attempt to block the blood flow by forming a clot. There are two general mechanisms to clot formation. In one mechanism, a clot begins to form when the blood is exposed to air. The platelets sense the presence of air and react with fibrinogen to begin forming fibrin. The resulting fibrin forms a web-like mesh that traps blood cells within it. In the other general mechanism, damaged blood vessels release a chemical signal that increases the stickiness of platelets in the area of the injury. The sticky platelets adhere to the damaged area and gradually form a platelet plug. At the same time, the platelets release a series of chemical signals that prompt other factors in the blood to reinforce the platelet plug. Between the platelet and its reinforcements, a sturdy clot is created that acts as a patch while the damaged area heals.

A critical function of the blood clotting system is to stop blood loss from injured tissues, such as tissues that have been damaged by wounds, surgery, or other trauma. However, sometimes the wound or trauma is so great that the blood system of the injured person is unable to rapidly and effectively stop all of the bleeding. Furthermore, while the clotting function is provided satisfactorily in most persons, in some persons the clotting system is impaired such that adequate clotting is not provided and extensive, sometimes deadly bleeding occurs as a result of injury or trauma. Thus, there are often times where a person is in need of additional platelets to provide the clotting function that is missing or inadequate.

In addition to their use “as is” to supply blood clotting functions to persons in need, platelets are studied extensively in the laboratory to characterize their properties and understand their precise role in the blood clotting cascade. Research on platelets provides information on blood clotting factors that are provided by the platelets, factors that interact with the platelets to promote clotting and wound healing, and factors that are necessary to activate platelets or otherwise attract the platelets to, and retain them at, a site of injury.

Both the therapeutic and research uses for platelets require that platelets be available in a form that is biologically active. Currently, platelets for therapeutic uses (e.g., infusion for wound healing) are typically provided as freshly isolated products, which are less than five days old. As can be immediately recognized, maintaining an adequate supply of fresh platelets for use by patients in need is costly and results in loss of a large amount of supplies due to expiration prior to use. Furthermore, because fresh platelets are so important for use in therapy, it is difficult and expensive to obtain those platelets for research purposes. Thus, there is a need in the art for alternatives to fresh platelets for therapy and research.

U.S. Pat. No. 5,622,867 to Livesey et al. discloses a system for cryoprotecting platelets for storage. The system treats fresh platelets with an inhibitor system comprising second messenger effectors. Inhibitors of one or more of the following pathways are added: cAMP, sodium channel, cGMP, cyclooxygenase, lipoxygenase, phospholipase, calcium, proteinase and proteinase, and membrane modification. A cryoprotectant, such as DMSO, maltodextrin, dextran, hydroxyethyl starch, and glucose, is also added where the platelets are to be maintained at low temperatures. Prior to use, the platelets are washed to remove the inhibitors and cryoprotectant.

U.S. Pat. No. 5,656,498 to Iijima et al. discloses freeze-dried platelets and methods of making them. The method comprises pre-treating platelets in blood plasma with a solution containing a saccharide, a biopolymer, an acid, or an acid salt, granulating the treated plasma, rapidly cooling the granules, and freeze-drying the granules.

U.S. Pat. No. 5,736,313 to Spargo et al. discloses freeze-dried platelets and a process for making them. The process of making the freeze-dried platelets comprises pre-incubating the platelets in a phosphate-citrate buffer or a phosphate-phosphate-citrate buffer, both of which contain a carbohydrate (e.g., glucose). After pre-incubation, the platelets are loaded with a carbohydrate, then suspended in a lyophilization buffer containing a matrix-forming polymer and a carbohydrate. The platelets are then slowly cooled to about −50° C. while the pressure is reduced to a vacuum state.

U.S. Pat. No. 5,958,670 and U.S. Pat. No. 5,800,978, both to Goodrich et al., also disclose freeze-dried platelets and methods of making them. The inventions disclosed in these patents rely on use of compositions having glass transition temperatures of above about −60° C. The compositions generally comprise a component that is permeable to the platelets (e.g., a carbohydrate, such as a sugar) and a component that is impermeable to the platelets (e.g., gelatin, PEG). To create the freeze-dried platelets, the temperature of the composition is reduced to a point below the glass transition temperature of the composition, and vacuum evaporating or subliming the liquid from the composition. An earlier patent, U.S. Pat. No. 5,213,814, also to Goodrich et al., discloses stabilized platelets and methods of making them. The methods and platelets are suitable for storage of the platelets for extended periods of time at about 4° C. The methods generally comprise immersing platelets in a buffered aqueous solution containing a carbohydrate and a biologically compatible polymer or mixture of polymers, then freezing the solution and drying the frozen solution to produce freeze-dried platelets containing less than 10% by weight of moisture.

U.S. Pat. No. 6,127,111 and U.S. Pat. No. 6,372,423, both to Braun, disclose freeze-dried platelets and methods of making them. The methods of making the freeze-dried platelets comprise exposing the platelets to a coagulation inhibitor (e.g., EDTA or citrate) and a “cake forming agent” (e.g., a protein such as serum albumin, or a polysaccharide such as mannitol) for about 5 to 60 minutes at room temperature, then freeze-dried to reduce the moisture content to below 10%.

Investigators at the University of California, Davis, have developed a process for making freeze-dried platelets. The process comprises loading the platelets with trehalose prior to freeze-drying. In U.S. Pat. No. 6,723,497, a method of preparing freeze-dried platelets is disclosed in which platelets are loaded with trehalose by incubating the platelets at a temperature from about 25° C. to less than about 40° C. with up to 50 mM trehalose, cooling the loaded platelets to below −32° C., and lyophilizing the cooled platelets. Published U.S. patent application 2005/0048460 discloses a method for making freeze-dried platelets that includes exposing the platelets to a carbohydrate (e.g., trehalose) and an amphiphilic agent (e.g., arbutin), and freeze-drying the platelets. See, for example, U.S. Pat. No. 6,770,478, U.S. Pat. Nos. 6,723,497, 5,827,741, and U.S. published patent applications Nos. 2005/0048460, 2004/0152964, 2004/0147024, and 2004/0136974.

U.S. Pat. No. 6,833,236 to Stienstra discloses a method for the production of stabilized platelets, and platelets made by the method. The method comprises pre-activating the platelets, for example by exposing them to stress, to induce formation of microvesicles, contacting the pre-activated platelets with a carbohydrate to introduce the carbohydrate into the platelets, and drying the loaded platelets.

Although these patents and patent applications provide various methods for preparing platelets that can be stored for later-use, there still exists a need in the art for improved methods of preparing freeze-dried platelets that are stable for long periods of time yet still functional upon rehydration.

### SUMMARY OF THE INVENTION

The present invention addresses needs in the art by providing methods for preparing freeze-dried platelets, freeze-dried platelets, methods of reconstituting or rehydrating freeze-dried platelets, and reconstituted platelets. The methods of the invention provide freeze-dried platelets that are stable for extended periods of time at room temperature or lower. They also provide freeze-dried platelets that, upon reconstitution, function well in the process of blood clotting, and thus can be used successfully in therapeutic applications, such as for wound healing and treatment of bleeding diseases and disorders.

In a first aspect, the invention provides a method for preparing or making (used interchangeably herein) freeze-dried platelets. In general, the method comprises providing platelets, suspending the platelets in a salt buffer that comprises at least one saccharide to make a composition, incubating the composition at a temperature above freezing for at least a sufficient time for the at least one saccharide to come into contact with the platelets, adding a cryoprotectant to make a second composition, and lyophilizing the second composition. In preferred embodiments, the method further comprises heating the lyophilized platelets, for example at 80° C. for 24 hours. In embodiments, the method further comprises the addition of 1% ethanol to the salt buffer to enhance the uptake of the saccharide into platelets.

In a second aspect, the invention provides freeze-dried platelets made by the method of the invention. The freeze-dried platelets of the invention are highly stable, having a shelf-life of at least six months. The freeze-dried platelets of the invention retain most, if not all, of the characteristics necessary for blood clotting function of the platelets when introduced into patients or subjects (used interchangeably herein) in need of platelet functions. Thus, the freeze-dried platelets of the invention may be used for both in vivo therapeutic purposes and in vitro diagnostics or research.

In a third aspect, the invention provides a method of making rehydrated or reconstituted platelets from the freeze-dried platelets of the invention. In general, the method of reconstituting comprises exposing freeze-dried platelets to an aqueous liquid in a sufficient amount and for a sufficient amount of time to rehydrate the platelets such that they regain a normal shape and fluid content. In embodiments, the amount of aqueous liquid is two times the volume of the dried platelets. In embodiments, the amount of aqueous liquid is equal to the volume of the dried platelets. In embodiments, the amount of aqueous liquid is equal to one-half the volume of the dried platelets. In other embodiments, the volume of the aqueous liquid is two times the volume of the composition prior to lyophilization. In other embodiments, the volume of the aqueous liquid is equal to the volume of the composition prior to lyophilization. In yet other embodiments, the volume of the aqueous liquid is one-half the volume of the composition prior to lyophilization.

In a fourth aspect, the invention provides rehydrated platelets. The rehydrated platelets of the invention possess all of the characteristics of platelets that are needed for normal blood clotting, when introduced into a subject in need of blood clotting functions. For example, the rehydrated platelets comprise all of the surface molecules necessary to participate in blood clot formation in a subject into which the platelets are introduced (i.e., a subject to whom the platelets are administered).

In yet another aspect, the invention provides a method of treating subjects suffering from bleeding due to wounds, surgery, or other traumas resulting in bleeding, or subjects suffering from a bleeding disease or disorder. In general, the method comprises administering freeze-dried or reconstituted platelets of the invention to the subject in an amount sufficient to reduce or eliminate the bleeding. Administration can be through any known technique, but is typically through infusion, injection, or direct application to the site of bleeding.

In another aspect, the invention provides a method of treating subjects suffering from congenital or acquired bleeding, such as congenital or acquired Hemophilia with Inhibitors; platelet defect diseases, such as Bernard-Soulier syndrome and Glanzmann thrombasthenia; autoimmune thrombocytopenia, alloimmune thrombocytopenia, drug-induced thrombocytopenia, thrombotic thrombocytopenic purpura, and other platelet-associated disorders. It also provides compositions and methods for prophylactically preventing or treating active excessive bleeding associated with anticoagulant therapy or other therapies or environmental effects that result in inhibition of the clotting cascade.

In another aspect, the present invention uses the composition as an active agent to provide normal or pseudo-normal hemostasis properties to hemophiliacs, and to provide hemostatic properties to hemophiliacs who have experience traumas resulting in bleeding. The invention further provides the composition for the treatment of drug-induced coagulopathy, and for the accelerated efficacy of procoagulant drugs in the presence of freeze-dried platelet derivatives.

In another aspect, the invention provides methods of treating individuals who are in need or suspected of being in need of one or more component of the clotting system of normal blood. In various embodiments, the individuals are hemophiliacs or patients who are undergoing treatment with anticoagulant agents. In yet other embodiments, the individuals are patients who have had their clotting system compromised in some other way, such as by liver failure, dialysis, or by exposure to environmental agents. In general, the method of this aspect of the invention comprises administering the composition of the invention to an individual (i.e., subject, patient) in an amount sufficient to raise the hemostatic properties of that individual's blood to a level that is detectably higher than it was before administration. The method can further comprise administering other biologically active agents, such as clotting factors, and chemotherapeutic agents for treatment of cancer. It can also comprise treatment with physical modalities, such as with radiation. It is envisioned that if fresh, indated platelets be used, one may optionally activate the platelets to provide a better hemostatic benefit towards the treatment of clotting disorders.

In another aspect, the composition can be used in conjunction with other hemostatic agents, such as recombinant FVIIa, to enhance the efficacy of the latter at otherwise sub-pharmacologic amounts, thereby saving cost and simplifying administration and treatment.

In another aspect, the invention provides kits. In general, kits of the invention comprise freeze-dried platelets of the invention. In embodiments, platelets are provided in a sufficient amount to treat a subject in need of platelets, such as a patient undergoing surgery or having a bleeding wound. In other embodiments, platelets are provided in a sufficient amount to perform studies on platelets or the blood clotting system of the species of animal from which the platelets originate.

### BRIEF DESCRIPTION OF THE DRAWINGS

The accompanying drawings, which are incorporated in and constitute a part of this specification, illustrate several embodiments of the invention and together with the written description, serve to explain certain principles and details of the invention.

FIG. 1 is a flow diagram showing steps involved in preparation of freeze-dried platelets according to a method known in the art and a method according to embodiments of the present invention.

FIG. 2 is a graph showing the effectiveness of freeze-dried platelets of an embodiment of the invention to promote plasma clotting in a dose-dependent manner.

FIG. 3 is a graph showing the effectiveness of freeze-dried platelets of an embodiment of the invention in promoting clot retraction.

FIG. 4 shows fluorescence activated cell sorting (FACS) analyses representing the results of assays of the size and granularity of reconstituted heat-treated freeze-dried platelets made according to an embodiment of the invention. Panel A, shows the size of reconstituted freeze-dried platelets and fresh platelets after various heat treatments. Panel B, shows the granularity of reconstituted freeze-dried platelets and fresh platelets after various heat treatments.

FIG. 5 shows FACS analyses showing the effect on platelet size of a post-lyophilization heat treatment step for 24 hours at various temperatures ranging from 75° C. (Panel B) to 80° C. (Panel C) to 85° C. (Panel D), with an unheated sample (Panel A) as control.

FIG. 6 shows FACS analyses showing the effect on platelet granulation of a post-lyophilization heat treatment step for 24 hours at various temperatures ranging from 75° C. (Panel B) to 80° C. (Panel C) to 85° C. (Panel D), with an unheated sample (Panel A) as control.

FIG. 7 depicts FACS analyses of fresh platelets (Panel A), freeze-dried platelets made according to a leading protocol known in the art (Panel B), and a protocol of the present invention (Panel C).

FIG. 8 depicts FACS analyses of reconstituted freeze-dried platelets and the effect of the presence of ethanol in the saccharide-loading buffer and lyophilization buffer.

FIG. 9 depicts a FACS analysis of relative amounts of HLA marker on the surface of freeze-dried platelets when produced according to an embodiment of the invention in which acid treatment is included.

### DETAILED DESCRIPTION OF VARIOUS EMBODIMENTS OF THE INVENTION

Reference will now be made in detail to various exemplary embodiments of the invention, examples of which are illustrated in the accompanying drawings. The following descriptions of various embodiments are provided to better describe particular features of those embodiments, and should not be considered as limiting the invention in any way to the particular features.

In a first aspect, the invention provides a method for preparing freeze-dried platelets. In general, the method comprises providing platelets, suspending the platelets in a salt buffer that comprises at least one saccharide to make a composition, incubating the composition at a temperature above freezing for at least a sufficient time for the at least one saccharide to come into contact with the platelets, adding a cryoprotectant to make a second composition, and lyophilizing the second composition.

It is to be noted at this point that each value stated in this disclosure is not, unless otherwise stated, meant to be precisely limited to that particular value. Rather, it is meant to indicate the stated value and any statistically insignificant values surrounding it. As a general rule, unless otherwise noted or evident from the context of the disclosure, each value includes an inherent range of 5% above and below the stated value. At times, this concept is captured by use of the term “about”. However, the absence of the term “about” in reference to a number does not indicate that the value is meant to mean “precisely” or “exactly”. Rather, it is only when the terms “precisely” or “exactly” (or another term clearly indicating precision) are used is one to understand that a value is so limited. In such cases, the stated value will be defined by the normal rules of rounding based on significant digits recited. Thus, for example, recitation of the value “100” means any whole or fractional value between 95 and 105, whereas recitation of the value “exactly 100” means 99.5 to 100.4.

The act of providing platelets can be any act that results in platelets being made available for use in the method in a form suitable for use in the method. Thus, providing can comprise removing blood from a subject and isolating or purifying (to any suitable extent) platelets from other blood components. Any known procedure for separating platelets from other blood components can be used. Accordingly, it can be through a process of obtaining platelets through plasmapheresis or sequential differential centrifugation of blood. For example, differential centrifugation can be used to isolate or purify platelets from other blood components through a two-step process in which blood is centrifuged at 3000×g for 45 minutes; platelet-poor liquid removed; the platelet-rich pellet resuspended in an aqueous buffer, and the mixture re-centrifuged at 200×g for 5 minutes to pellet the platelets. Alternatively, a single centrifugation step can be used, such as centrifugation at 100×g for 10 minutes. During the process of obtaining the platelets, one or more substances may be added to the compositions comprising the platelets, such as one or more anticoagulant or stabilizer.

The platelets may be from any source. Accordingly, they may be from an animal, such as a pig, horse, dog, cow, sheep, goat, rabbit, rat, mouse, monkey, or cat. They also may be from a human. In certain cases, the platelets may be provided as a mixture from two or more sources, such as a mixture of two or more units of blood obtained from random blood donors to a public blood bank. In other embodiments, such as embodiments where the platelets are intended to be used at a later date for infusion back into the donor, the platelets can be from a known source, and are thus considered autologous platelets for the purposes of the methods of treatment disclosed herein. In general, the platelets will be provided from a fresh source (i.e., in-dated platelets from blood obtained from a donor less than 6 days prior to freeze-drying), although out-dated platelets may be used in some situations, particularly for preparation of freeze-dried platelets intended for use in in vivo and in vitro for diagnostics or research.

The platelets that are provided are suspended in a salt buffer that comprises at least one saccharide, resulting in a platelet-containing composition. The salt buffer may be any buffer that maintains at least a majority of the platelets in an intact, functional state while in the buffer. Preferably, the buffer maintains the platelets at a pH of about 6.2 to about 7.8. Thus, the salt buffer may be an isotonic salt buffer comprising salts naturally encountered by platelets, such as those comprising sodium salts, potassium salts, calcium salts, and the like, and combinations of such salts. Alternatively, it may comprise one or more salts that platelets are not naturally in contact with. The identity of the salt(s) in the buffer are not critical so long as they are present in amounts that are not toxic to the platelets and maintain at least a majority of the platelets in an intact, functional state while in the buffer. Likewise, the buffering component may be any buffer that is non-toxic to the platelets and provides adequate buffering capacity to the composition at the temperatures at which the composition will be exposed during the method of the invention. Thus, the buffer may comprise any of the known biologically compatible buffers available commercially, such as HEPES and phosphate-buffered saline (PBS). Likewise, it may comprise one or more of the following buffers: propane-1,2,3-tricarboxylic (tricarballylic); benzenepentacarboxylic; maleic; 2,2-dimethylsuccinic; EDTA; 3,3-dimethylglutaric; bis(2-hydroxyethyl)imino-tris(hydroxymethyl)-methane (BIS-TRIS); benzenehexacarboxylic (mellitic); N-(2-acetamido)imino-diacetic acid (ADA); butane-1,2,3,4-tetracarboxylic; pyrophosphoric; 1,1-cyclopentanediacetic(3,3 tetramethylene-glutaric acid); 1,40piperazinebis-(ethanesulfonic acid) (PIPES); N-(2-acetamido)-2-amnoethanesulfonic acid (ACES); 1,1-cyclohexanediacetic; 3,6-endomethylene-1,2,3,6-tetrahydrophthalic acid (EMTA; ENDCA); imidazole;; 2-(aminoethyl)trimethylammonium chloride (CHOLAMINE); N,N-bis(2-hydroxyethyl)-2-aminoethanesulfonic acid (BES); 2-methylpropane-1,2,3-triscarboxylic (beta-methyltricarballylic); 2-(N-morpholino)propane-sulfonic acid (MOPS); phosphoric; N-tris(hydroxymethyl)methyl-2-amminoethane sulfonic acid (TES); and N-2-hydroxyethylpiperazine-N′-2-ethanesulfonic acid (HEPES). Furthermore, the buffer system can provide buffering capacity at the range of pH 4 to pH 8.

The salt buffer comprises at least one saccharide. The saccharide can be any suitable saccharide, including a monosaccharide or disaccharide or polysaccharide. The saccharide can be any saccharide that is compatible with maintenance of viability and function of platelets, and can be present in any amount that is not toxic to the platelets. In general, the saccharide can be any saccharide that is capable of passing through a cell membrane, such as the platelet membrane. Examples of suitable saccharides are sucrose, maltose, trehalose, glucose, mannose, xylose, Ficoll-70, and hydrogels having a molecular weight cut-off of less than about 100 kilodaltons. It is known that saccharides can be advantageously included in compositions for freeze-drying or lyophilizing platelets, and the present invention envisions use of at least one saccharide for stabilizing or otherwise promoting survival of platelets through the freeze-drying and reconstitution process. A preferred saccharide for use in the method of preparing freeze-dried platelets is trehalose. The saccharide may be present in the buffer in any suitable amount. For example, it may be present in an amount of 1 mM to 1 M. In embodiments, it is present in an amount of from 10 mM 10 to 500 mM. In some embodiments, it is present in an amount of from 20 mM to 200 mM. In embodiments, it is present in an amount from 40 mM to 100 mM. In certain particular embodiments, the saccharide is present in the buffer in an amount of at least or about any of the following concentrations: 40 mM, 50 mM, 60 mM, 70 mM, 80 mM, 90 mM, and 100 mM. Of course, in various embodiments, the saccharide is present in different specific concentrations within the ranges recited above, and one of skill in the art can immediately understand the various concentrations without the need to specifically recite each herein. Where more than one saccharide is present in the buffer, each saccharide may be present in an amount according to the ranges and particular concentrations recited above.

The salt buffer may comprise other components, as long as those components are non-toxic to the platelets at the concentration in which they are present in the buffer. Thus, polymers, such as proteins and polysaccharides, may be included in the buffer. Likewise, alcohols, such as ethanol, or polyalcohols, such as glycerols and sugar alcohols, may be included. Similarly, organic solvents, such as dimethyl sulfoxide (DMSO), can be included. Further, coagulation or platelet inhibitors, such as heparin, EGTA, citrate, and prostaglandin E (PGE).

In embodiments, the buffer comprises a cation-free HEPES-Tyrodes buffer (95 mM HEPES, 1 M NaCl, 48 mM KCl, 120 mM NaHCO₃) comprising 50 mM trehalose, pH 6.8. In other embodiments, the buffer comprises a cation-free HEPES-Tyrodes buffer comprising 100 mM trehalose and 1% (v/v) ethanol, pH 6.8.

The platelet-containing composition is incubated, at least in part to permit loading of the saccharide into the platelets. In general, the composition is incubated at a temperature above freezing for at least a sufficient time for the saccharide to come into contact with the platelets. Thus, incubation can be at 1° C., 4° C., 10° C., 20° C., 22° C., 25° C, 37° C., 42° C., 50° C., 55° C., or greater. In embodiments, incubation is conducted at 37° C. Furthermore, incubation can be performed for any suitable length of time, as long as the time, taken in conjunction with the temperature, is sufficient for the saccharide to come into contact with the platelets and, preferably, be incorporated, at least to some extent, into the platelets. In embodiments, incubation is carried out for at least or about 10 minutes, 20 minutes, 30 minutes, 40 minutes, 50 minutes, 60 minutes, 70 minutes, 80 minutes, 90 minutes, 100 minutes, 1 10 minutes, 120 minutes, 130 minutes, 140 minutes, 150 minutes, 160 minutes, 170 minutes, 180 minutes, or longer. In certain embodiments, incubation is performed at 20° C. to 42° C. for 100 minutes to 150 minutes. For example, in embodiments, incubation is performed at 35° C. to 40° C. (e.g., 37° C.) for 110 to 130 (e.g., 120) minutes. While incubation at higher temperatures than about 37° C. have been found to be suitable, it has been determined that such higher temperatures are unnecessary and, in embodiments, provide less than superior results. Furthermore, while incubation times greater than about 2 hours have been found to be suitable, it has been determined that such longer times are unnecessary and, in embodiments, provide less than superior results. Furthermore, reducing the time to 2 hours from, for example, 4 hours, reduces the time required to produce freeze-dried platelets, and provides an advantage for the practitioner over some other methods available in the art. In embodiments where activated platelets are desired, incubation times approaching or exceeding 4 hours in the presence of trehalose may be used. However, to reduce the amount of activation and minimize loss of structural integrity, incubation times of less than 4 hours, such as 2 hours, are more suitable.

The methods of the present invention provide advantages of prior methods of making freeze-dried platelets. One advantage is the ability to omit platelet activation inhibitors. Because incubation can be performed for shorter periods of time than used in prior art methods, the platelets are not activated, or if activated, only activated to a relatively low level. Thus, in embodiments of the methods of the present invention, it is not necessary to add platelet activation inhibitors to inhibit activation of the platelets while loading them with saccharides. This not only lowers the cost and complexity of the procedure, but eliminates the need to remove the inhibitors at a later time before use, such as prior to lyophilization or after rehydration.

The method of freeze-drying platelets comprises adding a cryoprotectant to the platelet composition to make a second composition, referred to from here out as the lyophilization buffer. The lyophilization buffer comprises, in addition to the components discussed above, a cryoprotectant (also referred to herein as an excipient). The cryoprotectant can be any suitable substance that protects, at least to some extent, the platelets during the subsequent freezing and thawing procedures. Various cryoprotectants are known in the art, and any of those may be used in an amount that is effective and non-toxic to the platelets. Examples of suitable cryoprotectants include, but are not limited to, bovine serum albumin, human serum albumin, dextran, polyvinyl pyrolidone (PVP), starch, hydroxyethyl starch (HES), and polysugars, such as Ficoll-70 and Ficoll-400. The cryoprotectant is included in the lyophilization buffer at an amount of from 1% to 50% (w/v), such as from 5% to 40%, 5% to 30%, 5% to 20%, and 5% to 10%. In embodiments, the cryoprotectant is present in the lyophilization buffer at a final concentration of 1%, 2%, 3%, 4%, 5%, 6%, 7%, 8%, 9%, or 10%. In certain embodiments, the cryoprotectant is present in the lyophilization buffer in a final concentration of 4%-8%. In embodiments, the excipient is serum albumin, such as bovine serum albumin or human serum albumin. In other embodiments, the excipient is not from an animal or human source. In these embodiments, the excipient is selected so as to reduce the likelihood that contaminants, such as infectious particles, are introduced into the platelet preparations. For example, when human serum albumin is used, there is the possibility that the albumin could be contaminated with one or more infectious particles (e.g., a virus). Likewise, if bovine serum albumin is used, there is a possibility that the albumin could contain immunogenic particles that could cause an adverse reaction if administered to a human patient. Thus, it is preferred in certain embodiments to use an excipient that is not from a biological source, such as Ficoll-400. Adding of the cryoprotectant to the loading buffer is accomplished without an intervening centrifugation or other separation step. That is, the cryoprotectant (and other optional components) is added directly to the loading buffer to make a second buffer suitable for direct lyophilization. This contrasts with currently available protocols in the art, which require a separation step between saccharide loading and lyophilization.

The method of making freeze-dried platelets comprises lyophilizing, or freeze-drying, the second composition. Numerous protocols for lyophilization of eukaryotic cells and cell-like particles, including platelets, are known in the art, and any suitable protocol may be used. As used herein, lyophilization or freeze-drying is a method of drying a substance using a combination of cold temperature and vacuum. Typically, the procedure uses freezing of the substance followed by dessication by sublimation and/or desorption of water and other liquids through the use of a vacuum. In general, lyophilization results in platelets having a water content of less than 10%. In embodiments, lyophilization results in platelets having a water content of less than 5%, such as 4%, 3%, 2%, 1%, or even less. It is known in the art that, in general, the lower the water content achieved, the more stable (e.g., longer shelf-life) of the resulting freeze-dried platelets. Thus, in embodiments, it is preferred to reduce the water content to as low of an amount as possible. Preferably, the water content is reduced to 2% or less, which is an amount that minimizes deleterious effects of a post-lyophilization heat step (where used), and promotes long-term stable storage of the freeze-dried platelets.

One example of a suitable lyophilization protocol includes freezing the lyophilization composition at −45° C. for 2 hours, maintaining the frozen composition at - 40° C. for 150 minutes at a vacuum of about 100 mTorr, and slowly raising the temperature, in 10° C. increments, to 25° C. (at about 100 mTorr vacuum) over a six hour period. Another example of a suitable lyophilization protocol includes freezing the lyophilization composition at −45° C. for about 4.5 hours, maintaining the frozen composition at −45° C. to −40° C. for one hour under a vacuum of 100 mTorr, and slowly raising the temperature, in 10 degree steps, to 30C over a 24 hour period at 100 mTorr vacuum.

In some embodiments, the method of preparing freeze-dried platelets further comprises heating the lyophilized platelets. It has surprisingly been found that a heat treatment step after lyophilization improves the stability of the freeze-dried platelets, and provides platelets that, upon rehydration, are highly active. Heating can be performed at any temperature above 25° C. Preferably, the heat treatment is performed at a temperature greater than 40° C., such as at a temperature greater than 50° C., a temperature greater than 60° C., a temperature greater than 70° C., or a temperature greater than 80° C. In particular embodiments, heating is conducted at 70° C.-85° C., such as at 75° C., 80° C., 85° C., or any other specific temperature within the range of 75° C. to 85° C., inclusive. The temperature for heating is selected in conjunction with the length of time that heating is to be perform ed. Although any suitable time can be used, typically, the lyophilized platelets are heated for at least 1 hour, but not more than 36 hours. Thus, in embodiments, heating is performed for at least 2 hours, at least 6 hours, at least 12 hours, at least 18 hours, at least 20 hours, at least 24 hours, or at least 30 hours. For example, the lyophilized platelets can be heated for 18 hours, 19 hours, 20 hours, 21 hours, 22 hours, 23 hours, 24 hours, 25 hours, 26 hours, 27 hours, 28 hours, 29 hours, or 30 hours. Non-limiting exemplary combinations include: heating the freeze-dried platelets for at least 30 minutes at a temperature higher than 30° C.; heating the freeze-dried platelets for at least 10 hours at a temperature higher than 50° C.; heating the freeze-dried platelets for at least 18 hours at a temperature higher than 75° C.; and heating the freeze-dried platelets for 24 hours at 80° C. While not necessary, it is preferred that heating be performed on lyophilized platelets that are in a sealed container, such as a capped vial. In addition, while not required, it is preferred that the sealed container be subjected to a vacuum prior to heating.

The heat treatment step, particularly in the presence of a cryoprotectant such as albumin or Ficoll-400, has been found to improve the stability and shelf-life of the freeze-dried platelets. Indeed, advantageous results have been obtained with the particular combination of serum albumin or Ficoll-400 and a post-lyophilization heat treatment step, as compared to those cryoprotectants without a heat treatment step. For example, advantageous results have been obtained by using a combination of Ficoll-400 at about 6% and a post-lyophilization heat treatment step at about 80° C. for about 24 hours.

In addition, the method can optionally comprise rehydrating the freeze-dried platelets. Rehydration can be by any suitable technique, such as those commonly used in the art. Typically, rehydration comprises exposing the freeze-dried platelets to water or an aqueous solution in an amount sufficient to partially or fully rehydrate the platelets. Suitable rehydrating solutions are known in the art and include, without limitation, phosphate buffered aqueous compositions (e.g., PBS). Certain particular rehydration compositions are provided below in the Examples. In embodiments, the rehydration buffer can have a formulation similar to the lyophilization buffer so that any initial deleterious effect of water on the freeze-dried platelets can be minimized. Exemplary rehydration buffers can be, but are not limited to, whole blood, plasma, serum, and aqueous solutions containing bovine serum albumin, human serum albumin, dextran, polyvinyl pyrolidone (PVP), starch, hydroxyethyl starch (HES), and polysugars, such as Ficoll-70 and Ficoll-400. These can be included in the aqueous rehydration buffer at an amount of from 1% to 50% (w/v), such as from 5% to 40%, 5% to 30%, 5% to 20%, and 5% to 10%. In embodiments, these are present in the rehydration buffer at a final concentration of 1%, 2%, 3%, 4%, 5%, 6%, 7%, 8%, 9%, or 10%. In certain embodiments, these are present in the rehydration buffer in a final concentration of 4%-8%.

The method of preparing freeze-dried platelets according to the invention does not require a centrifugation step between incubating the platelets in the salt buffer and lyophilizing. Rather, the lyophilization composition may be created directly from the salt buffer composition, and freeze-dried platelets produced from that lyophilization composition directly. This is in contrast to methods currently in use in which two distinct buffers are used to prepare lyophilized platelets (e.g., a “loading buffer” and a “lyophilization buffer”), and where the platelets are removed from the first buffer (and typically washed) prior to exposure to the second buffer.

The method of preparing freeze-dried platelets according to the present invention provides platelet-containing compositions with high levels of intact platelets as compared to microparticles and other substances resulting from lysis of platelets. Thus, like current techniques that rely on use of DMSO or formaldehyde to produce lyophilized or otherwise dried platelet preparations, the present invention provides compositions with high levels of intact platelets. Yet, unlike the DMSO or formaldehyde protocols, there is no need to wash the reconstituted platelets of the present invention before use.

In embodiments of the method of preparing freeze-dried platelets, the method comprises an HLA reduction step. This step is optional and can be used to produce low-HLA content platelets. Low-HLA content platelets have been reported to be beneficial for in vivo therapeutic use in subjects having a strong immunogenic reaction to platelet therapies. In embodiments where an HLA reduction step is included, the buffer for the reduction step can be any suitable buffer, such as a cation-free HEPES-Tyrodes buffer (95 mM HEPES, 1 M NaCl, 48 mM KCl, 120 mM NaHCO₃) and 10 mM EGTA, pH 4. To effect HLA reduction, the platelets can be incubated in the buffer for a suitable amount of time, such as two hours. Although the HLA reduction step can be performed at any point in the process, it is preferred that it be performed prior to the saccharide loading step. Thus, in embodiments, HLA-deficient platelets can be achieved by incubation in the appropriate buffer prior to saccharide loading, then washed and incubated in a loading buffer, such as one comprising a cation-free HEPES-Tyrodes buffer comprising 100 mM trehalose and 1% (v/v) ethanol, pH 6.8.

The method of preparing freeze-dried platelets according to the present invention provides platelets with intact surface receptors, such as Glycoprotiens IIb-IIIa and Glycoproteins Ib, that are involved in various platelet functions, such as adhesion to the subendothelial matrix to initiate and participate in the clotting process.

The method of preparing freeze-dried platelets according to the present invention also provides platelets with intact intracellular organelles, such as dense and alpha granules that are involved in various platelet functions, such as intracellular signaling, promotion of vasoconstriction, and release of molecules that further promote platelet activation and aggregation at the site of injuries. Accordingly, the method can be practiced on other non-nucleated eukaryotic cells or cell fragments, including, but not limited to red blood cells. As used herein, the term “platelet” refers to such other non-nucleated eukaryotic cells and cell fragments. Likewise, the method can be practiced to prepare stabilized macromolecules or complexes of macromolecules, such as, but not limited to, proteins, nucleic acids, viruses, and the like. Indeed, because the methods of the present invention provide stabilized products that can be stored for extended periods of time in stable form at room temperature and without the need for refrigeration or freezing, it can be practiced on any number of biological or chemical substances, including those specifically mentioned herein and other like substances.

In a second aspect, the invention provides freeze-dried platelets made by the method of the invention. The freeze-dried platelets are suitable for both in vitro diagnostic and research purposes as well as in vivo therapeutic purposes. For example, the freeze-dried platelets can be rehydrated and used to treat subjects suffering from excessive bleeding or suffering from a bleeding disorder. Alternatively, they can be used to study platelet function in the laboratory setting, or to research the effect of platelets or platelet components on the blood clotting system. One of skill in the art can envision numerous specific diseases and disorders that can be treated with platelets, and all of those diseases and disorders can be treated with the freeze-dried platelets of the invention.

The freeze-dried platelets of the invention retain most, if not all, of the characteristics needed for adequate blood clotting. Thus, for example, the freeze-dried platelets of the invention retain normal size (upon rehydration), intact membranes, normal aggregation properties, proper surface protein arrays, and internal factors that participate in the clotting cascade. That is, the freeze-dried platelets of the invention retain most, if not all, of the characteristics necessary for blood clotting function of the platelets when introduced into patients or subjects in need of platelet functions.

The freeze-dried platelets of the invention are highly stable, having a shelf-life of at least six months at room temperature or below. For example, the freeze-dried platelets can be stable up to one year at room temperature or below, up to 18 months at room temperature or below, or even longer. By “stable” it is meant that the platelets, when rehydrated, function within normal parameters for in-dated platelets, and provide adequate blood clotting functions when administered to a subject in need. This stability is of great advantage in providing platelet products to those in need, particularly those found at sites some distance from blood collection centers. Furthermore, because the freeze-dried platelets can be stored at room temperature, complicated, bulky, or expensive containers for storage (e.g., refrigerators) are not needed. In addition, because the platelets can be stored in the dehydrated state, significant savings in volume and weight can be achieved, as compared to fresh, concentrated platelets.

The freeze-dried platelets of the invention are highly stable, even when exposed to high gamma irradiation dose of 50 kGY or heat treated at 80° C. for 24 hrs. This property is advantageous in that it enables the platelets to be treated for pathogen reduction.

In addition, freeze-dried platelets made according to methods of the invention, upon rehydration, show properties of fresh or in-dated platelets. For example, upon rehydration, they show the swirling characteristic of fresh or in-dated, unactivated platelets. Furthermore, upon rehydration, they show a similar size and granularity as fresh or in-dated platelets. Other characteristics of the freeze-dried platelets, upon rehydration, are mentioned below.

In another aspect, the invention provides a method of making rehydrated or reconstituted platelets from the freeze-dried platelets of the invention. In general, the method of reconstituting comprises providing freeze-dried platelets and exposing them to an aqueous liquid in a sufficient amount and for a sufficient amount of time to rehydrate the platelets such that they regain a normal shape and fluid content. In embodiments, the method of making rehydrated or reconstituted platelets comprises the same actions as the optional step of rehydrating the freeze-dried platelets disclosed above as part of the method of making freeze-dried platelets. However, the method of rehydrating can be a separate method practiced independently in time and/or place of the method of making freeze-dried platelets. More specifically, because the freeze-dried platelets of the invention may be stored for extended periods of time in a stable form, the method of rehydration may be practiced months or years after the method of making the freeze-dried platelets. In addition, the method of rehydration includes rehydrating the platelets to an extent that the platelets regain normal size, shape, and function, whereas the rehydration step of the method of making freeze-dried platelets includes partial as well as complete rehydration, without regard to shape, size, or function.

The freeze-dried platelets are platelets made according to the methods provided herein. In particular embodiments, they are freeze-dried platelets that have been made by a process that includes a final heat treatment step at 75° C.-85° C. for 18-30 hours. They can be provided as freshly-prepared freeze-dried platelets or as freeze-dried platelets that have been stored for one week or more. The source of the freeze-dried platelets is not critical to practice of this aspect of the invention; however, it is preferred that, for rehydration of platelets for therapeutic uses, the freeze-dried platelets be from an in-dated source.

In the situation where the supply of indated platelets are limited, outdate platelets can be used because the platelets produced using the current invention can be subjected to pathogen reduction and HLA reduction steps without compromising platelet functions. To provide the most advantageous results, outdated platelets should be used within 3 days out dated (i.e., by day 9 after removal from the donor). That is, if platelets are expired on the 5^{th} date, outdated platelets can be used on the 6^{th}, 7^{th} or 8^{th} date using the procedure from the current invention.

According to the method of rehydrating, the freeze-dried platelets are exposed to an aqueous liquid. The aqueous liquid may be water, or it can be a liquid comprising water and one or more other substances, such as salts or buffers. Typically, the liquid will be an aqueous buffer, such as PBS, an aqueous composition comprising another biologically compatible buffer (e.g., HEPES) or whole blood, plasma, serum, or any osmotically balanced biological buffers. In embodiments, the rehydration buffer comprises a high molecular weight polymer, such as a poly-sugar. Included among these polymers is Ficoll-400. In embodiments, the rehydration buffer can also comprise bovine serum albumin, human serum albumin, dextran, polyvinyl pyrolidone (PVP), starch, and hydroxyethyl starch (HES). Preferably, the rehydration buffer comprises components that promote retention of platelet integrity, such as those that provide the correct osmotic pressure.

The platelets are exposed to the liquid in a sufficient amount and for a sufficient amount of time to rehydrate the platelets such that they regain a normal shape and fluid content. The amount of liquid and amount of time will vary depending on the final concentration of platelets desired, the buffer, and the temperature at which the platelets are rehydrated. In embodiments, the amount of aqueous liquid is two times the volume of the dried platelets. While any temperature may be used, in general it will be most convenient to rehydrate the platelets at ambient room temperature (e.g., 20° C.-25° C.). The rehydration time can be any appropriate time. Thus, it can range from 10 seconds to over one hour. For example, it can be about one minute or less, about five minutes or less, about ten minutes or less, about 30 minutes or less, and about 60 minutes or less. In embodiments, rehydration can be accomplished by physically resuspending the platelets (e.g., by swirling or pipetting) for 10-30 seconds, then letting the platelets stand undisturbed at room temperature for 5 minutes.

Furthermore, rehydration can be performed using any known general protocol. Thus, the platelets can be rehydrated directly with the rehydration liquid or can be rehydrated indirectly or passively. Direct methods can include directly applying a volume of liquid to the freeze-dried platelets, such as by adding the liquid to a pellet of platelets, and allowing the liquid sufficient time to contact the platelets and rehydrate them. Direct rehydration can also comprise physically dispersing the platelets at one or more times while in contact with the liquid, such as by swirling or pipeting gently. In embodiments of direct rehydration, the rehydration buffer is gently added to the freeze-dried platelets and allowed to stay in contact with them in an undisturbed state for 10-60 seconds, such as for 30 seconds, then the platelets are gently swirled for a few seconds to disburse them in the liquid, then allowed to sit undisturbed for 1-10 minutes at room temperature. Where desired, the platelets can be gently agitated one or more times by swirling or pipeting during the rehydration period. In other embodiments, the platelets are rehydrated by direct addition of the rehydration buffer, then immediate gentle pipeting until complete dispersion is observed. The platelets then can be permitted to remain undisturbed for 1-10 minutes or more, either with or without one or more brief gentle periods of agitation. In other embodiments, passive rehydration can be used. Examples of passive rehydration include rehydration by exposure to rehydration buffer vapor, then exposure to the rehydration buffer liquid. The practitioner is well aware of various methods for rehydrating freeze-dried platelets, and any suitable method may be used.

In another aspect, the invention provides rehydrated platelets. The rehydrated platelets of the invention, on average, possess all of the characteristics of platelets that are needed for normal blood clotting, when introduced into a subject in need of blood clotting functions. Thus, the rehydrated platelets are of the same size as fresh platelets. They also have the same generally disc shape as fresh platelets and the same volume. The complement of molecules on the surface of the rehydrated platelets is the same as that of fresh platelets, as are the functions provided by these molecules. Accordingly, the rehydrated platelets can participate normally in the clotting process, both under in vitro conditions and when re-introduced to an in vivo environment.

Interestingly, the rehydrated platelet preparations of the invention contain few microparticles. In general, freeze-drying techniques known in the art result in freeze-dried platelets that, when reconstituted, provide adequate platelet functions. However, they typically result in high numbers of microparticles being present, ostensibly due to lysis of a large number of platelets during the freeze-drying and/or rehydration procedures. Unlike other freeze-drying methods in the art, the present methods provide reconstituted platelet preparations with a relatively low number of microparticles. The high ratio of intact, properly sized platelets to microparticles is advantageous for use of the platelet preparations in therapeutic regimens.

In assays for aggregation function, assayed by percent aggregation by single cell count, it was found that reconstituted platelets of the invention had advantageous properties, as depicted in Table 1.

TABLE 1
Aggregation Characteristics of Reconstituted Platelets

| | % Aggregation by Single Cell |
|---|---|
| Agonist | Count |
| Arachidonic Acid | 77 |
| Collagen | 83 |
| Epinephrine | 86 |
| TRAP Peptide | 93 |
| Ristocetin | 97 |
| None | 10 |

When freshly prepared freeze-dried platelets and freeze dried platelets that had been stored at room temperature for 6 months were reconstituted and assayed for certain characteristics, it was found that they both had the following characteristics: adhesion to subendothelium matrix proteins; aggregation in response to various agonists; maintenance of primary receptors; function in concert with autologous platelets; procoagulant activity; retention of overall size and granulation; promotion of clotting in vitro in whole blood and plasma models; retention of functional activities upon heating and gamma irradiation treatment; and stability of greater than 90% (instantaneous reconstitution). Thus, freeze dried platelets that have been stored for 6 months at room temperature are expected to function in the same manner as freshly prepared freeze-dried platelets.

As for surface markers, reconstituted freeze-dried platelets of the present invention have been found to possess the levels of surface markers indicated in Table 2. If an HLA reduction step is incorporated in the method of preparing the platelets, the levels of HLA can be reduced to 5% (100%). These values compare favorably with the values that can be obtained using reconstituted freeze-dried platelets made by other methods known in the art. The results presented in Table 2 are based on reconstituted freeze-dried platelets made by a method of the present invention (see Examples I and 2, below) and fresh platelets.

TABLE 2
Expression of Selected Surface Markers on Freeze-Dried Platelets
Prepared from Multiple Random Donor Units

| Surface | | | Example 1 |
|---|---|---|---|
| Marker | Fresh Platelets | Example 2 Protocol | Protocol |
| GP Ib | 100% | 65-75% | 5-10% |
| GP IIb/IIIa | 100% | 100% | 100% |
| HLA | 100% | 5% (w/acid reduction) | 100% |
| | | 100% w/o acid reduction) | |
| P-Selectin | 5-10% | 80% | 100% |
| Resting | | | |
| P-Selecting | 100-140% | 100% | 100% |
| Active | | | |

In different embodiments, the reconstituted platelets can have different levels of activation. Depending on various factors, including among other things the temperature and length of time of saccharide loading, the moisture content of the platelets after freeze-drying, and whether or not a post-lyophilization heat step is included, the platelets of the present invention have proved to show a range from low levels of activation to higher levels. By practicing the steps of certain embodiments of the invention, one can obtain freeze-dried platelets that, upon reconstitution, are not fully activated. This is a property unlike other platelet preparations provided by freeze-drying techniques known in the art. Thus, in embodiments, the reconstituted platelets of the invention show, upon visual inspection, swirled platelets. The swirly characteristic disappears upon exposure to agonists, such as arachidonic acid, collagen, epinephrin, TRAP peptide, and ristocetin. Furthermore, reconstituted platelets have been found to aggregate into a clot that can be detected visually upon exposure to the agonists. Additionally, the levels of surface marker GP Ib remains high (˜60-100%).

Activated platelets cease to swirl and bind to the protein Annexin V. The surface of activated platelets express other proteins (such as P-selectin), and the levels of the surface-protein GP Ib decrease to about 10% of the original levels. Only the expression of P-selectin and binding to Annexin V were detected on freeze-dried platelets of the present invention. Thus, based on these brief summaries, the reconstituted freeze-dried platelets tested for Table 2 retained most of the unactivated characteristics and some of the activated characteristics commonly found in normal platelets.

Thus, it is important to recognize that the current invention provides a method for long term preservation and storage of platelets in a dry format, where the platelets are easy to store and transport, and are convenient to use.

It is also important to recognize that the current invention provides a protocol that stabilizes platelets and upon reconstitution with suitable buffer, provides functional platelets. It is to be understood that the processes disclosed herein will also confer non-nucleated eukaryotic cells with biological capabilities similar to fresh platelets. It should be understood that the present methods constitute novel methods to maintain non-nucleated eukaryotic cells and cell fragments in the dry state while maintain their biological functions upon reconstitution. Likewise, the methods of the present invention can be used to freeze-dry less complicated biological material, such as lipids, lipid vesicles, viral particles, viral coats, proteins, and nucleic acids.

The freeze-dried platelets and rehydrated freeze-dried platelets of the invention are suitable for many uses. Indeed, because they can have characteristics of fresh or in-dated platelets, they can be used for any therapeutic purpose that fresh or in-dated platelets would be used for. For example, the rehydrated platelets of the invention can be used as a blood substitute or supplement for treatment of excessive bleeding, such as that seen in wounded subjects or subjects undergoing surgery. Furthermore, the freeze-dried platelets can be included as part of a wound-healing bandage (for example, about 1×10⁸-1×10⁹ platelets per cm³) to provide platelet functions to sites of wounds. They likewise can be used to treat disorders relating to reduced or missing platelet function. In addition, because the platelets have characteristics of fresh or in-dated platelets, they can be used in diagnostic assays to -determine various functions of the blood clotting system of subjects. Furthermore, they can be used in research settings to elucidate the characteristics of platelets, to study the clotting cascade, and to identify cellular components that are involved in blood hemostasis and other biological functions.

In a further aspect, the invention provides kits. In general, kits of the invention comprise freeze-dried or reconstituted platelets of the invention. In view of the shelf stability of freeze-dried platelets of the invention, preferred kits comprise freeze-dried platelets. The kits can also comprise some or all of the other reagents and supplies necessary to perform at least one embodiment of one method of the invention. Thus, the kits can be diagnostic kits, blood clotting monitoring kits for coagulation proteins or platelets, or drug treatment monitoring kits. Kits can also be containers containing freeze-dried platelets or reconstituted platelets, often for administration to patients in need of platelet functions. Often, the kits will comprise some or all of the supplies and reagents to perform one or more control reactions to ensure the kits are performing properly and to provide baseline results against which test samples can be compared.

In its simplest form, a kit according to the invention is a container containing at least one platelet composition according to the invention. Thus, in embodiments, the kit of the invention comprises a container containing freeze-dried platelets. In other embodiments, the kit comprises a container containing reconstituted freeze-dried platelets. Regardless of the state of hydration of the platelets, in embodiments, the kit comprises multiple containers, each of which may contain the platelets or other substances that are useful for performing one or more diagnostic protocol, one or more treatment protocol, or one or more research experiment. In other embodiments, the kit comprises additional components, which may be contained in the same or one or more different containers. Like the compositions it holds, in its various forms, the kit of the invention can comprise substances that are useful for in vitro-study of platelets, such as to detect and/or study of various platelet characteristics and functions; to calibrate instruments; to isolate and purify platelet cytoplasmic molecules or platelet granules (alpha and dense granules); to study platelet and microparticle interactions among themselves and with other components of the blood clotting system; and to study anti-platelet medications and platelet or coagulation inhibitors.

The container can be any material suitable for containing a composition of the invention or another substance that can be contained in the kit. Thus, the container may be a vial or ampule. It can be fabricated from any suitable material, such as glass, plastic, metal, or paper or a paper product. In embodiments, it is a glass or plastic ampule or vial that can be sealed, such as by a stopper, a stopper and crimp seal, or a plastic or metal cap. In general, the container and seal are made of materials that can be sterilized by heat (dry or wet), radiation (UV, gamma, etc.), or exposure to chemicals. Preferably, the container is sterilized before the platelet composition of the invention is introduced into the container. Typically, the container will be of sufficient size to contain the platelet composition of the invention, yet have head space to permit addition of other substances, such as sterile water, saline, an aqueous buffer, or a mixture of these, which can be used to rehydrate a freeze-dried platelet composition in the container.

In embodiments, the container comprises a sufficient amount of platelet-containing material to administer to a patient in need of platelets, or to perform at least one assay for platelet function, or to perform at least one diagnostic assay. The amount of platelet-containing material contained in the container can be selected by one of skill in the art without undue experimentation based on numerous parameters that are relevant to performing any of these activities.

In embodiments, the container is provided as a component of a larger unit that typically comprises packaging materials (referred to below as a kit for simplicity purposes). The kit of the invention can include suitable packaging and, optionally, instructions and/or other information relating to use of the platelet-containing compositions. Typically, the kit is fabricated from a sturdy material, such as cardboard or plastic, and can contain the instructions or other information printed directly on it. In embodiments, the kit comprises other components, such as, but not limited to, purified components of the clotting cascade and drugs affecting the clotting cascade. The kit can comprise multiple containers containing platelet-containing compositions of the invention. In such kits, each container can be the same size, and contain the same amount of composition, as each other container, or different containers may be different sizes and/or contain different amounts of compositions or compositions having different constituents. One of skill in the art will immediately appreciate that numerous different configurations of container sizes and contents are envisioned by this invention, and thus not all permutations need be specifically recited herein.

In general, the kit comprises containers to contain the components of the kit, and is considered a single package comprising one or a combination of containers. Thus, the components are said to be in packaged combination within the kit. In addition to a container containing the composition of the invention, the kit can comprise additional containers containing additional compositions of the invention. The various containers may contain differing amounts of the composition of the invention. Thus, in embodiments, the kit comprises a sufficient amount of platelets to perform a method of treating. In embodiments, the kit comprises other components, such as purified components of the clotting cascade. The kit can further comprise some or all of the supplies and materials needed to prepare for and perform a particular in vitro or in vivo method, such as, but not limited to, sterile water or a sterile aqueous solution (e.g., saline). In some embodiments, the kits comprise one or more liquids to hydrate the compositions of the kits. The liquid may be any suitable liquid, but is typically a water-based liquid, such as water or saline.

In embodiments, platelets are provided in the kit in a sufficient amount to treat a subject in need of platelets, such as a patient undergoing surgery or having a bleeding wound. For example, the kit can comprise one or more vials containing 1×10⁸ to 1×10⁹ platelets each for wound therapy. A treatment regime using such a kit could comprise administering the platelets (after rehydrating) in 10 doses. In other embodiments, platelets are provided in the kit in a sufficient amount to perform studies on platelets or the blood clotting system of the species of animal from which the platelets originate. In yet other embodiments, platelets are provided in the kit in a sufficient amount to perform at least one diagnostic assay for at least one function of the blood clotting system, such as a platelet function. For example, a kit for diagnostic purposes could comprise multiple vials, each containing from 200,000 to 1,000,000 platelets.

In embodiments, the kit comprises more than one container containing the freeze-dried platelets. In embodiments, the kit is simply a container containing an amount of freeze-dried platelets equivalent to the amount of platelets in one liter or one pint of blood. In embodiments, the kit comprises human freeze-dried platelets.

### EXAMPLES

The invention will be further explained by the following Examples, which are intended to be purely exemplary of the invention, and should not be considered as limiting the invention in any way.

### Example 1

### Preparation of Freeze-Dried Platelets

A method of preparing freeze-dried platelets was developed to provide platelets having a long shelf-life and suitable characteristics upon rehydration. The method was found to provide freeze-dried platelets, and platelets reconstituted from those freeze-dried platelets, with advantageous properties for in vitro studies and in vivo therapeutic applications.

The method of preparing freeze-dried platelets comprised the following:

An initial saccharide-loading process included:

all solutions, buffers, equipment, etc. were checked to ensure that each was at or near room temperature to minimize adverse effects of cold temperatures on the platelets;

platelet-rich plasma (PRP) was obtained;

the suitability of the platelets was checked by checking swirling—if no swirling was noticed, the platelets were rejected;

the pH of the platelet composition was checked and samples having a pH lower than 6.2 were rejected;

where applicable, different samples of platelets (e.g., PRP) were pooled in a plastic beaker;

the platelet composition was stirred and the pH measured—if necessary, the pH was adjusted to 6.6-6.8 with ACD buffer (85 mM Sodium Citrate; 65 mM Citric Acid; 111 mM glucose; in deionized ultrafiltered water; filtered);

the platelet count was determined on an ACT-10 instrument, and dilutions were made to get the platelets within the linear range of the ACT-10 (about 10 to 1000);

platelets were divided equally into different centrifuge bottles;

where necessary, red blood cells (RBC) were removed by centrifugation in a fixed angle centrifuge at 500×g for 5 minutes—platelet rich plasma fraction was then removed to a new clean bottle and a new platelet count taken;

where desired, a sample of the PRP was taken for later analysis (5-10 ml);

platelets were pelleted by centrifugation at 1500×g for 15 minutes;

platelet poor plasma was removed by aspiration and saved for later use, if desired;

the pelleted platelets were resuspended in a minimal volume (equal to about 5% of the volume of the platelet poor plasma removed in the previous step) of Loading Buffer (9.5 mM HEPES; 100 mM NaCl; 4.8 mM KCl; 5.0 mM glucose; 12 mM NaHCO₃; 50 mM trehalose; pH 6.8);

the resuspended platelets were measured for platelet counts, and the concentration adjusted to approximately 1250 (1.25×10⁹/ml, as measured by the ACT-10 machine);

the volume was recorded;

the platelets were incubated at 37° C. in a waterbath for two hours;

during the incubation period, a clot retraction assay was performed to compare the PRP with platelet-poor plasma—if platelets failed to contract the clot as compared to the platelet-poor plasma, the platelet preparation was rejected;

after incubation, human serum albumin was added to a final concentration of 5% (w/v);

the final platelet concentration was measured on the ACT-10 machine; and

the platelet composition was lyophilized as follows:

TABLE 3
Lyophilization Protocol

Shelf Temp
(° C.)

| Period | Time (h) | Start | End | Vacuum (mTorr) |
|---|---|---|---|---|
| 1 | 0.63 | 30 | −45 | ambient |
| 2 | 4 | −45 | −45 | ambient |
| 3 | 1 | −45 | −40 | 100 |
| 4 | 12 | −40 | −30 | 100 |
| 5 | 12 | 30 | 30 | 100 |

### Example 2

### Preparation of Freeze-Dried Platelets

A second method of preparing freeze-dried platelets was developed to provide platelets having a long shelf-life and suitable characteristics upon rehydration. The method was found to provide freeze-dried platelets, and platelets reconstituted from those freeze-dried platelets, with highly advantageous properties for in vitro studies and in vivo therapeutic applications.

The method of preparing freeze-dried platelets comprised the following:

An initial saccharide-loading process included:

all solutions, buffers, equipment, etc. were checked to ensure that each was at or near room temperature to minimize adverse effects of cold temperatures on the platelets;

platelet-rich plasma (PRP) was obtained;

the suitability of the platelets was checked by checking swirling—if no swirling was noticed, the platelets were rejected;

the pH of the platelet composition was checked and samples having a pH lower than 6.2 were rejected;

where applicable, different samples of platelets (e.g., PRP) were pooled in a plastic beaker;

the platelet composition was stirred and the pH measured—if necessary, the pH was adjusted to 6.6-6.8 with ACD buffer (85 mM Sodium Citrate; 65 mM Citric Acid; 111 mM glucose; in deionized ultrafiltered water; filtered);

the platelet count was determined on an ACT-10 instrument, and dilutions were made to get the platelets within the linear range of the ACT-10 (about 10 to 1000);

where necessary, red blood cells (RBC) were removed by centrifugation in a fixed angle centrifuge at 500×g for 5 minutes—platelet rich plasma fraction was then removed to a new clean bottle and a new platelet count taken;

where desired, a sample of the PRP was taken for later analysis (5-10 ml);

platelets were pelleted by centrifugation at 1500×g for 15 minutes;

platelet poor plasma was removed by aspiration and saved for later use, if desired;

the pelleted platelets were resuspended in a minimal volume (equal to about 10% of the volume of the platelet poor plasma removed in the previous step) of Loading Buffer (9.5 mM HEPES; 100 mM NaCl; 4.8 mM KCl; 5.0 mM glucose; 12 mM NaHCO₃; 50 mM trehalose; pH 6.8);

the resuspended platelets were measured for platelet counts, and the concentration adjusted to approximately 1250 (1.25×10⁹/ml, as measured by the ACT-10 machine);

the volume was recorded;

the platelets were incubated at 37° C. in a waterbath for two hours;

during the incubation period, a clot retraction assay was performed to compare the PRP with platelet-poor plasma—if platelets failed to contract the clot as compared to the platelet-poor plasma, the platelet preparation was rejected;

after incubation, Ficoll 400 was added to the platelets to give a final concentration of 6% (w/v);

the final platelet count was measured on an ACT-10 machine (the count typically was approximately 1000 (1×10⁹/ml);

the platelets were aliquotted and lyophilized using the same lyophilization protocol described in Example 1;

After lyophilization, the vials in which the platelets were lyophilized were stoppered under vacuum, capped immediately, and baked in an oven at various temperatures and times.

Where desired, the platelets were rehydrated with the same volume as the pre-lyophilization volume of the rehydration buffer added to the dried platelets. For example, if 1 ml of composition was lyophilized, then 1 ml of reconstitution buffer was added for rehydration.

The rehydration process usually involved the addition of distilled water; 6% Ficoll-400 in distilled water or 6% Ficoll-400, 2 mM Calcium Chloride in distilled water.

The rehydrated platelets were allowed to equilibrate at room temperature for 30 seconds to 300 seconds before use.

### Example 3

### Comparative Example of Method Used in the Art to Produce Freeze-Dried Platelets

To produce freeze-dried platelets for comparison to those made according to embodiments of the present invention, a protocol known in the art was used to make freeze-dried platelets. The method included:

PRP were obtained by centrifugation of blood (in CPD or CPDA anticoagulant solution) at 320×g for 14 minutes using a by centrifugation at 320g for 14 min using a swinging bucket rotor and no centrifugation breaking;

PRP were removed and transferred to fresh tubes, taking care to avoid contamination with RBC;

PGE₁ in ethanol was added to 10 ug/ml from a 100× stock, and platelets were counted;

platelets were centrifuged at 480×g for 25 minutes;

the platelet-poor supernatant was removed by aspiration;

platelets were resuspended in 1×10⁹/ml in Tyrodes Phosphate Buffer, pH 6.8 containing 5 mM glucose and 40 mM trehalose, with 2 mM Mg²⁺ plus 10 ug/mL PGE1 (added at 1:100 from 1 mg/ml stock) (i.e., 4.63 mM Na₂HPO₄, 5.37 mM NaH₂ PO₄, 120 mM NaCl, 2.67 mM KCl, 2 mM NaHCO₃, 5 mM glucose, 2mM MgCl₂, 40 mM trehalose, pH 6.8 (+10 ug/ml PGE1 from 1 mg/ml stock in EtOH);

a small amount was saved for further assay, if desired;

the sample was incubated 4 hours at 37° C., mixing by gentle inversion every half hour;

a sample was removed, where desired, for functional testing (e.g., aggregometry and FACS);

the composition was centrifuged at 480×g for 15 minutes;

the supernatant was removed by aspiration;

the pellet was resuspended to 1-2×10⁹/ml in isotonic HEPES saline containing 5% Human Serum Albumin, 100 mM Trehalose, and 1 mM MgCl₂, pH 6.8 (i.e., 9.5 mM HEPES, 75 mM NaCl, 4.8 mM KCl, 1.00 mM MgCl₂, 100 mM trehalose, 5% Human Serum Albumin, pH 6.8);

platelets were counted on an ACT-10 machine, and the platelet count and volume recorded;

where desired, a sample was removed and saved for later testing (e.g., functional testing);

platelets were transferred to lyophilization vials with stopper caps and the contents of each vial weighed;

platelets were lyophilized using the same lyophilize cycle from Example 1;

lyophilized platelets were sealed in the lyophilization vials under vacuum;

lyophilized platelets were stored at ambient temperature or at 2-8° C. in the absence of dessicant; and

where desired, the freeze-dried platelets were rehydrated with sterile water as follows: volume of water to add=weight of vial prior to lyophilization minus the weight of the vial after lyophilization, assuming 1 ml of water=1.0 g.

To determine the characteristics of freeze-dried platelets made according to an embodiment of the present invention, freeze-dried platelets made according to Example 2 above were rehydrated in distilled water and tested for various physical and functional properties.

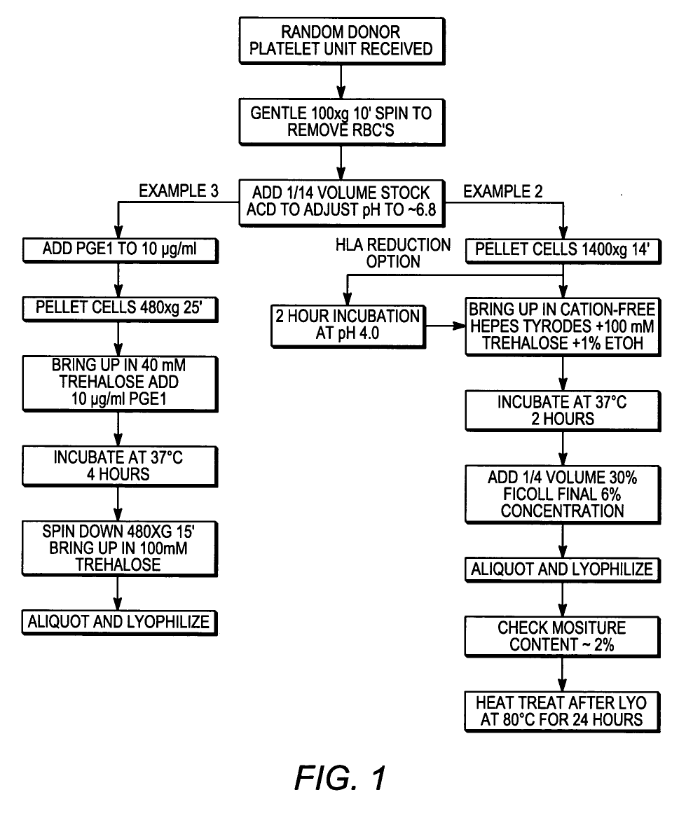

A graphical flow-chart comparison of the protocols presented in Examples 1 and 2, along with an optional HLA reduction step (detailed below) and the comparative protocol of Example 3 is presented in FIG. 1.

### Example 4

### Characterization of Freeze-Dried Platelets Prepared According to Example 2

To determine the characteristics of freeze-dried platelets made according to an embodiment of the present invention, freeze-dried platelets made according to Example 2 above were rehydrated as described above and tested for various physical and functional properties.

In one set of experiments, the reconstituted platelets' ability to promote plasma clot times in a dose-dependent manner was assayed. For these experiments, 100 ul of APCT (activated plasma clot time, Analytical Control Systems, Inc., Fishers, Ind.) reagent was mixed with 25 ul of various concentrations of water-reconstituted freeze-dried platelets and 25 ul of plasma obtained from commercial suppliers. The mixture was incubated at 37° C. in a water bath for 3 minutes, then 100 ul of 0.02 M CaCl₂ (37° C.) was added, and clot time determined.

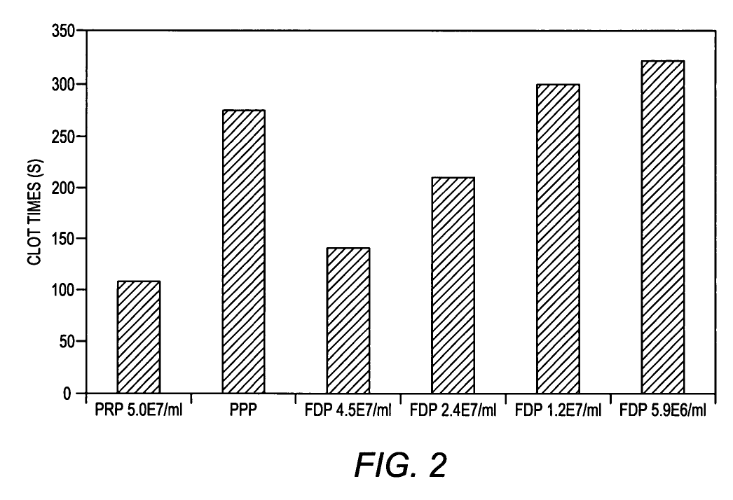

As can be seen from FIG. 2, the reconstituted freeze-dried platelets made according to Example 2 promote plasma clotting dimes in a dose-dependent manner, in a similar fashion as fresh platelets. More specifically, FIG. 2 shows the clotting times for various preparations, including platelet-rich plasma (PRP; lane 1), platelet-poor plasma (PPP), and freeze-dried platelets (FDP) of the invention at various concentrations. It can be seen that the FDP show at least as good of clotting ability as PRP, but a drop in clotting effectiveness as the number of platelets is reduced.

In another set of experiments, the ability of reconstituted FDP made by the protocol of Example 2 to promote clot retraction was tested. Briefly, the procedure involved: addition of about 4.5×10⁷ reconstituted platelets per ml to 1 ml of platelet-poor plasma. To this, 0.02 M CaCl₂ was added and incubated at 37° C. Initial formation of clots was measured and at 30 minutes, the length of the clot was measured again. The amount of clot retraction was calculated based on the length of clot at time zero and at time 30 minutes.

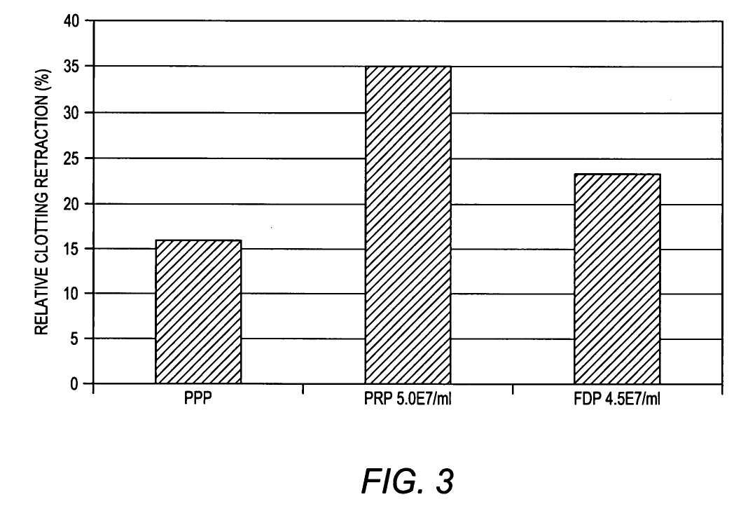

As can be seen from FIG. 3, reconstituted freeze-dried platelets of the invention can promote clot retraction in the same manner as fresh platelets. More specifically, the relative clot retraction amount is higher in reconstituted FDP than in PPP, and somewhat lower than a similar amount of PRP.

### Example 5

### Effect of Post-Lyophilization Heat Step on Size and Granularity of Freeze-Dried Platelets

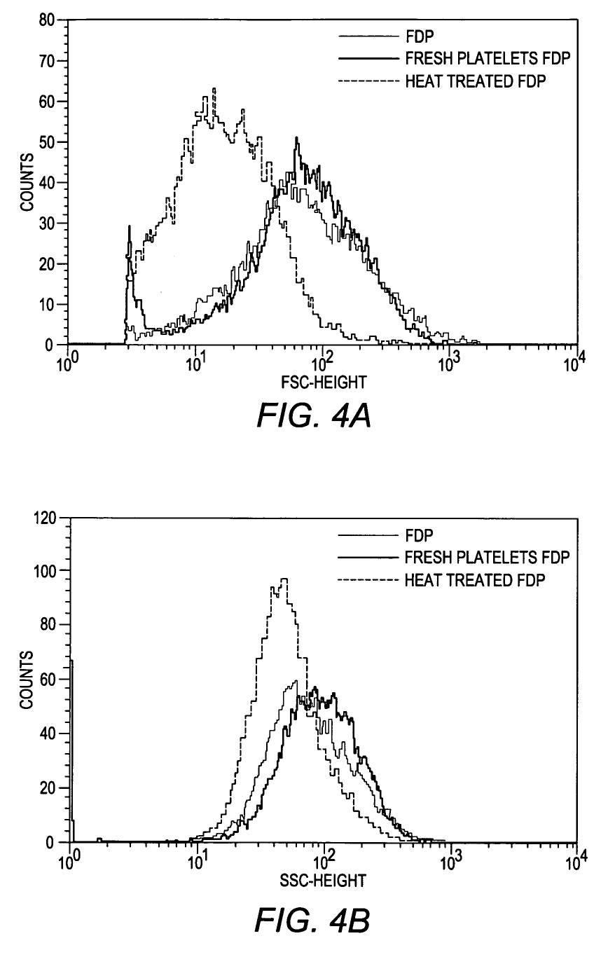

To determine the effect of the post-lyophilization treatment step of the protocol described in Example 2, the size and granularity of reconstituted platelets made by that protocol were examined and compared to the size and granularity of fresh platelets treated in the same manner. Experiments were performed on a Becton Dickenson FACS caliber instrument using log-log settings. Platelets were characterized by their representative forward and side scatter light profiles (performed using gel filtered platelets) and by the binding of the FITC anti-human CD 41. Platelets were diluted to ˜50,000 per ul in HBMT in separate tubes and Fluorescence-labeled antibodies were added at saturation for 30 minutes at ambient temperature. Samples were diluted with 2 ml HMBT and 10,000 individual events collected. The fluorescence histogram and percentage of positive cells were recorded, and this represented the platelet population that bound to the fluorescence labeled antibody. The results are presented in FIGS. 4-6.

FIG. 4 shows graphs representing the results of experiments to assay the size and granularity of reconstituted freeze-dried platelets made according to Example 2, made with and without the post-lyophilization heat treatment step. Size distribution (FIG. 4A) and granularity (FIG. 4B) of heat treat reconstituted FDP (heated at 80° C. for 24 hours) are virtually identical to fresh platelets whereas the non-heat treated reconstituted FDP are smaller in size and de-granulated

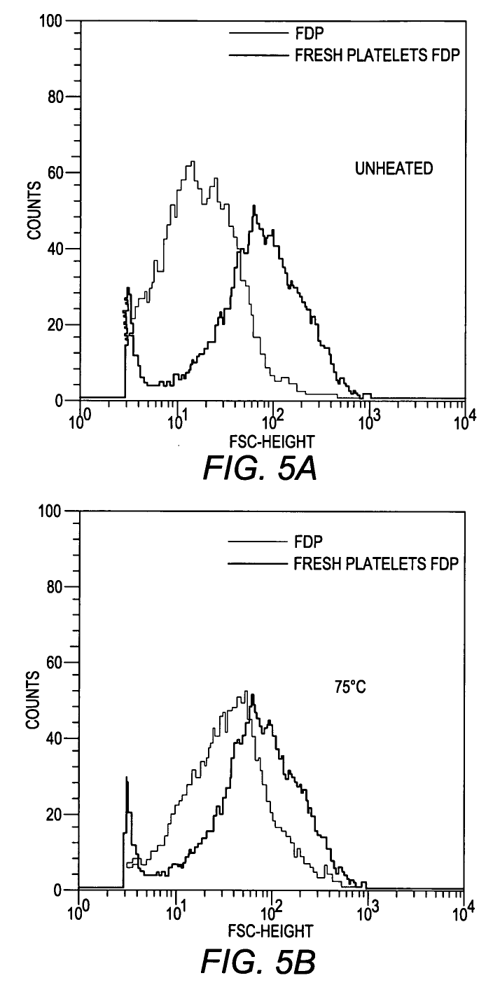

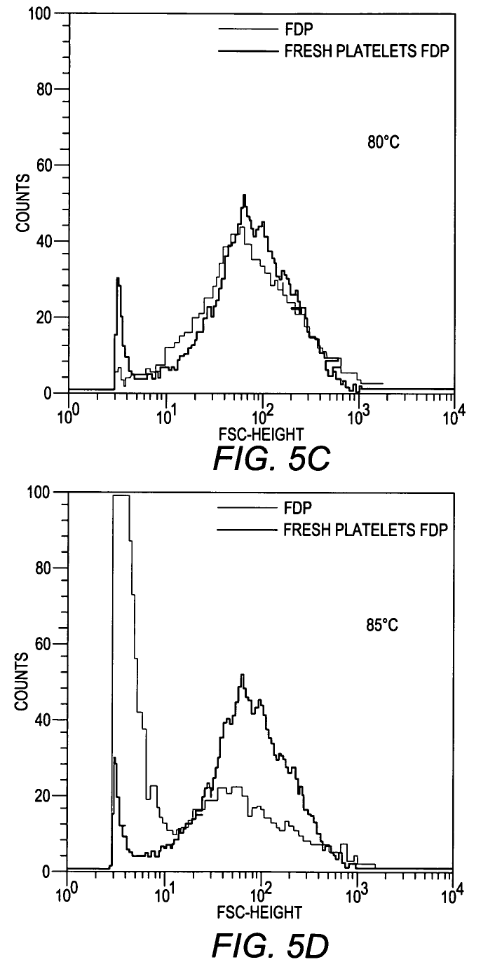

FIG. 5 shows the effect of a post-lyophilization heat treatment step on platelet size at various temperatures ranging from 75° C. to 80° C. to 85° C., with an unheated sample as control. More specifically, freeze-dried platelets made according to the procedure described in Example 2 were produced identically to each other, up to the point of heat treatment. At the heat treatment step, samples were heated at 75° C., 80° C., or 85° C. for 24 hours, or maintained at room temperature for 24 hours. Fresh platelets in plasma were prepared right before the comparative analysis. The samples from each time point for each temperature were combined, and the size of the platelets assayed using FACS analysis. The results, which are shown in FIG. 5, show that heating of freeze-dried platelets at temperatures up to 80° C. for 18-24 hours improves the size of the platelets (i.e., promotes size retention, as compared to fresh platelets), but that the beneficial effects drop off at 85° C. or higher. Similar results were obtained for treatment for 18 hours (data not shown).

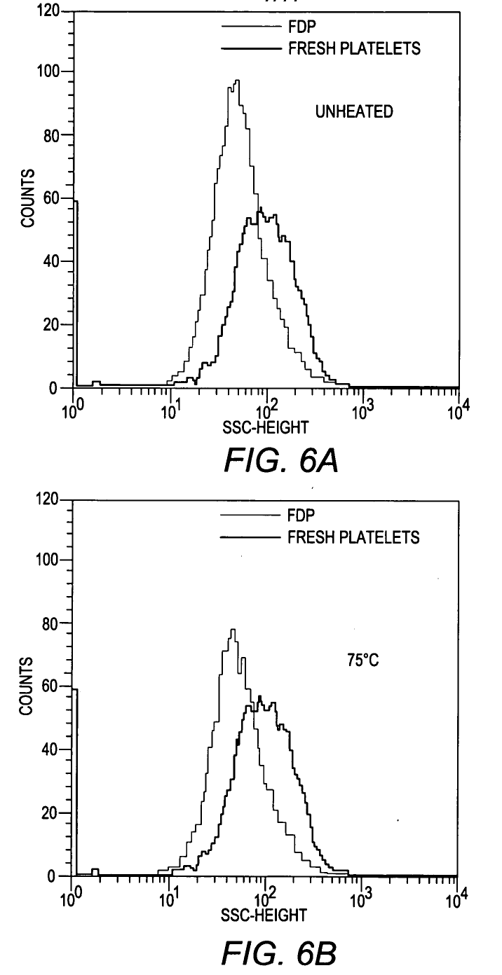

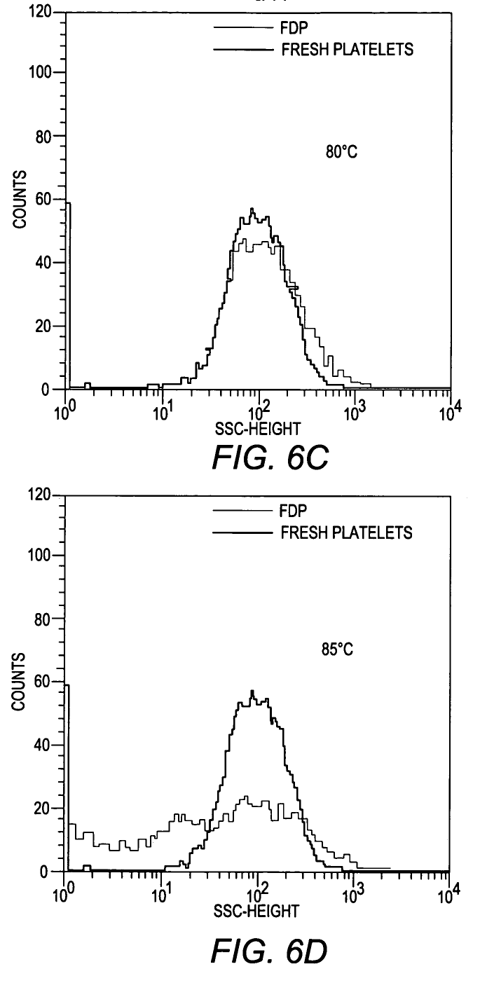

FIG. 6 is a graph showing the effect on platelet granulation of a post-lyophilization heat treatment step for 24 hours at various temperatures ranging from 75° C. to 80° C. to 85° C., with an unheated sample as control. More specifically, freeze-dried platelets made according to the procedure described in Example 2 were produced identically to each other, up to the point of heat treatment. At the heat treatment step, samples were heated at 75° C., 80° C., or 85° C. for 24 hours, or maintained at room temperature for 24 hours. Fresh platelets in plasma were prepared before the analysis. The samples from each time point for each temperature were combined, and the granularity of the platelet preparations was assayed using FACS analysis. The results, which are shown in FIG. 6, show that heating of freeze-dried platelets at temperatures up to 80° C., and particularly at about 80° C., for 24 hours improves the granularity of the platelets (i.e., mimics the granularity of fresh platelets), but that the beneficial effects drop off at 85° C. or higher. Similar results were obtained for incubations for 18 hours (data not shown).

### Example 6

### Effect of Post-Lyophilization Heat Treatment on Size of Freeze-Dried Platelets as Compared to Other Methods

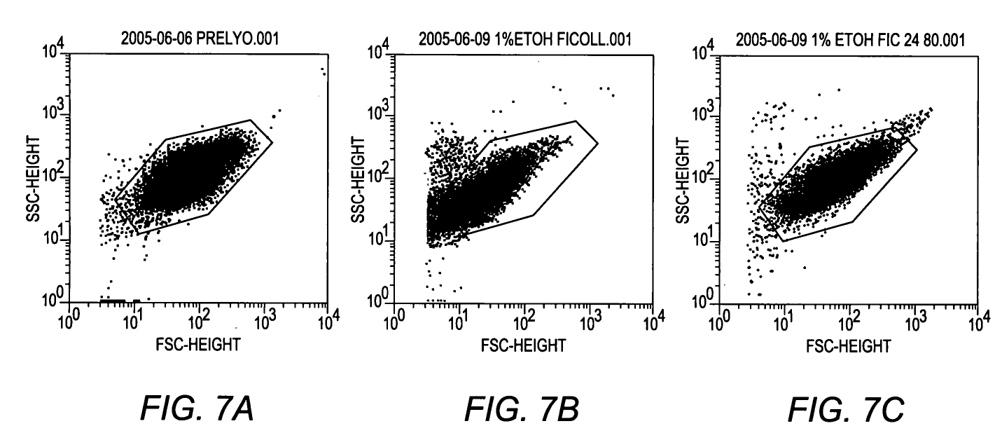

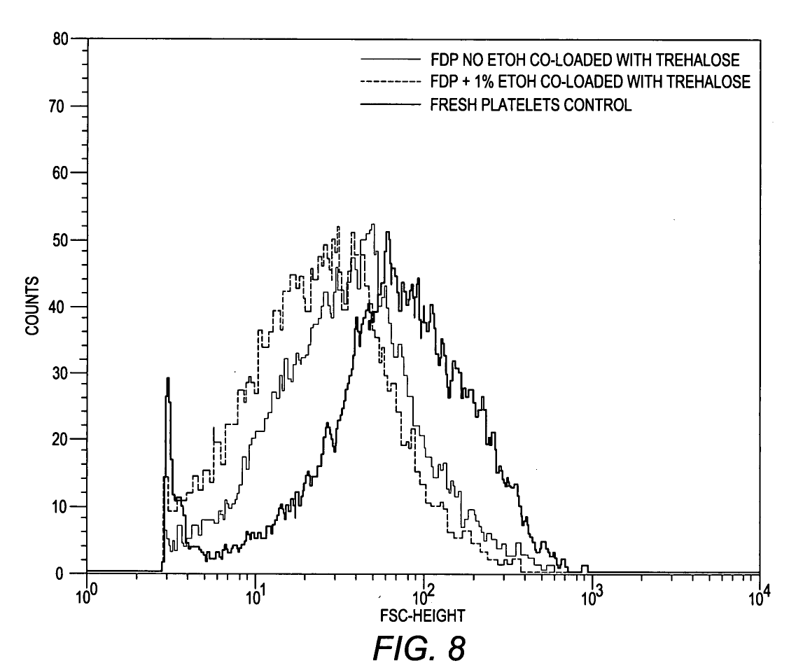

To determine the suitability of the freeze-dried platelets of the invention, and particularly those produced using the heat-treatment step disclosed in Example 2, three samples were assayed for size. The first sample comprised fresh platelets in plasma. The second sample comprised reconstituted platelets prepared according to the comparative method of Example 1, where the freeze-dried platelets were reconstituted with distilled water. The third sample comprised reconstituted freeze-dried platelets made according to Example 2, using a post-lyophilization heat treatment of 24 hours at 80° C. and were reconstituted with distilled water. Each sample was subjected to FACS analysis as described above, and the results are presented in FIG. 7.

The results in FIG. 7 depict the average size and granularity of each sample. The sample containing fresh platelets was analyzed (FIG. 7A), and a gate or window placed on the FACS graph to indicate the area where essentially all of the platelets were positioned. The sample containing reconstituted freeze-dried platelets made according to the comparative example of Example 3 was similarly analyzed, and a gate or window placed on the FACS graph at the same position as in FIG. 7A. Finally, the sample containing reconstituted freeze-dried platelets made according to the protocol disclosed in Example 2 was similarly analyzed, and a gate or window placed on the FACS graph at the same position as in FIG. 7A. As can be seen from a comparison of FIGS. 7A, 7B, and 7C, the sample comprising reconstituted freeze-dried platelets according to the present invention showed an almost identical size and granularity distribution, as compared to fresh platelets, whereas the reconstituted platelets made by the comparative example were significantly shifted outside the area where fresh platelets were located. This example shows that reconstituted freeze-dried platelets made according to a method of the present invention are more similar to fresh platelets than reconstituted freeze-dried platelets made by a protocol known in the art.

### Example 7

### Characterization of Bio Activities of Freeze-Dried Platelets Prepared According to Example 2

To demonstrate the reconstituted freeze-dried platelets can aggregate in response to the addition of agonists, various agonists (Arachidonic Acid at 0.5 mg/ml, Collagen at 10 ug/ml, Epinephrine at 300 uM, Thrombin Receptor Activating Peptide (TRAP:SFLLRN) at 10 mM, and Ristocetin at 1 mg/ml plus 20% Citrated Plasma and saline were added to 400 ul of reconstituted freeze-dried platelets at 250,000 platelets per ul in HEPES-Tyrodes Buffer containing 0.3% bovine serum albumin (BSA) to final volume of 500 ul. Aggregation of the platelets was determined after 5 minutes at room temperature. Platelets were counted using a standard Complete Blood Count machine (ACT 10 from Beckman coulter). The results showed that freeze-dried platelets aggregated in response to Arachidonic Acid, Collagen, Epinephrine, thrombin receptor activing peptide (TRAP), and Ristocetin with aggregation percentages determined to be 77, 83, 86, 93, 97, and 10, respectively (see Table 1, above).

### Example 8

### Characterization of Platelet Surface Markers upon Reconstitution

In another series of experiments, reconstituted freeze-dried platelets made according to Example 2, with a heat-treatment step of 80° C. for 24 hours, were assayed for common surface markers of platelets. Experiments were performed using FACS analysis as indicated above using the following fluorescence antibodies:

| | |
|---|---|
| Isotype | BD Pharminagen Mouse IgG kappa |
| HLA | BD Pharminagen anti-human HLA-A-B-C |
| GPIb | DakoCytomation mouse anti-human CD42b clone AN51 |
| IIbIIIa | DakoCytomation mouse anti-human CD41 clone 5b12 |
| P-selectin | BD Pharminagen anti-human CD62P (cat# 555523). |

To determine the ability of freeze-dried platelets of the invention to retain surface receptors that are relevant for platelet function, FACS analyses were performed on fresh platelets prepared right before the experiment; those produced using the heat-treatment step disclosed in Example 2, and those produced according to the comparative method of Example 1. All freeze-dried platelets were reconstituted with distilled water.

As noted, for base line computation to fresh platelets, the following values are readjusted and normalized into percentages. The percent of the constitutively expressed receptors GP1b, GPIIb/IIIa and HLA were set at 100% for fresh platelets. For P-selectin, the protein does not express when platelets are resting (5-10% expression on the average) and fully expresses when platelets are active (100%).

The freeze-dried platelets produced using the heat-treatment step disclosed in Example 2 showed a percent of constitutively expressed receptors GP1b and GPIIb/IIIa ranging from 65-75% and 100%, respectively, with respect to fresh platelets. For HLA, when acid treated, the levels of HLA expression reduced to 5%, whereas they remained at 100% when not acid treated, with respect to fresh platelets. For P-selectin, the protein constitutively expressed whether or not the freeze-dried platelets were active or resting. The results are shown in tabular form in Table 2, above.

Thus, the heat treatment step indicated in Example 2 can help to preserve the expression of GPIb, an important protein for hemostasis.

### Example 9

### Effect of Ethanol in the Saccharide-Loading Buffer and the Lyophilization Buffer

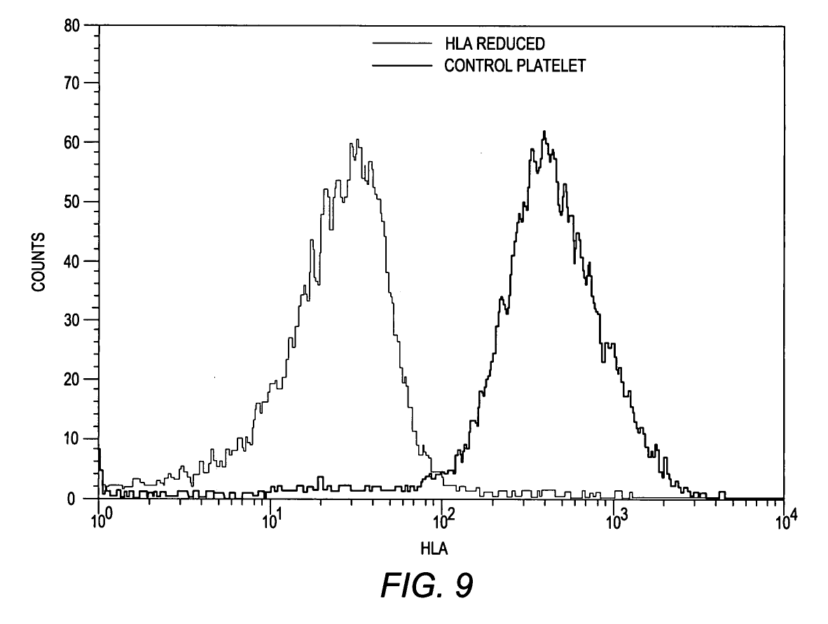

The protocol according to one embodiment of the present invention includes ethanol in the saccharide-loading buffer and the lyophilization buffer. To determine the effect of the presence of ethanol in these buffers, freeze-dried platelets were made according to the method of Example 2, heat treated at various temperatures for 24 hours, reconstituted, and assayed for size and granularity. More specifically, FACS analyses of fresh platelets (control), reconstituted freeze-dried platelets loaded with trehalose, but without ethanol in the loading buffer or lyophilization buffer, and reconstituted freeze-dried platelets loaded with trehalose in the presence of 1% ethanol and lyophilized in the presence of 0.8% ethanol, were performed. The results are presented in FIG. 9.

As can be seen in FIG. 9, the presence of ethanol in both the loading buffer and the lyophilization buffer improved the size distribution of reconstituted freeze-dried platelets as compared to a similar protocol performed in the absence of ethanol. In contrast, it had no significant effect on the granularity of the reconstituted platelets. For the first time, the current invention provides evidence to show that the inclusion of ethanol in the loading and, in particular, lyophilization buffers helps to stabilize the platelets and promote platelet saccharide uptake in the loading step.

### Example 10

### HLA Reduction

One embodiment of the process of preparing freeze-dried platelets of the invention includes an optional HLA reduction step. To determine the usefulness of this optional step in conjunction with the processes described in Examples 1 and 2, the optional step was performed just after the initial pelleting of platelets in each of those Examples. The details of the HLA reduction for each Example is provided below.

The pelleted platelets from Examples 1 and 2 were resuspended in a minimal volume of Reduction Buffer (9.5 mM HEPES; 100 mM NaCl; 4.8 mM KCl; 5.0 mM glucose; 12 mM NaHCO₃; 100 mM EGTA pH 4.0), where the minimal volume of reduction buffer defined in this step was equal to about 10% of the volume of the platelet poor plasma removed in the previous step. After 2 hours of incubation at room temperature, the platelets were washed 3 times with wash buffer (9.5 mM HEPES; 100 mM NaCl; 4.8 mM KCl; 5.0 mM glucose; 12 mM NaHCO₃ pH 6.8), same volume as reduction buffer, and pelleted as before.

The option step can be build into the protocol to provide the flexibility of reducing the immunogenicity of the composition. Freeze-dried platelets made according to Example 2 above were rehydrated in distilled water and tested for the amount of HLA on the surface of the platelets. To analyze for HLA content on the surface of the freeze-dried platelets, these experiments were performed on a Becton Dickenson FACS caliber instrument using log-log settings. Platelets were characterized by their representative forward and side scatter light profiles (performed using gel filtered platelets) and by the binding of the FITC anti-human HLA-A-B-C. Platelets were diluted to 50,000 per ul in HBMT in separate tubes and Fluorescence-labeled antibodies were added at saturation for 30 minutes at ambient temperature. Samples were diluted with 2 ml HMBT and 10,000 individual events collected. The fluorescence histogram and percentage of positive cells were recorded, and this represented the platelet population that bound to the fluorescence labeled antibody.

As can be seen from FIG. 10, without acid treatment, the controlled platelets expressed strong fluorescence signal, whereas, for the platelets that were treated acidic buffer as outlined in example 2, the fluorescence signal decrease by almost 95%.

It will be apparent to those skilled in the art that various modifications and variations can be made in the practice of the present invention without departing from the scope or spirit of the invention. Other embodiments of the invention will be apparent to those skilled in the art from consideration of the specification and practice of the invention. It is intended that the specification and examples be considered as exemplary only, with a true scope and spirit of the invention being indicated by the following claims.

1. A method of preparing freeze-dried platelets, said method comprising:
providing platelets,
suspending the platelets in a salt buffer that comprises at least one saccharide to make a first composition,
incubating the first composition at a temperature above freezing for at least a sufficient time for the at least one saccharide to come into contact with the platelets,
adding a cryoprotectant to make a second composition,
wherein the first composition is not subjected to centrifugation or other separation procedure before the cryoprotectant is added, and
lyophilizing the second composition to make freeze-dried platelets.

2. The method of claim 1, further comprising heating the freeze-dried platelets for at least 10 hours at a temperature higher than 50° C.

3. The method of claim 1, further comprising heating the freeze-dried platelets for at least 18 hours at a temperature higher than 75° C.

4. The method of claim 1, further comprising heating the freeze-dried platelets for 24 hours at 80° C.

5. The method of claim 1, further comprising adding ethanol to the second composition or to both the first composition and the second composition.

6. The method of claim 5, wherein the ethanol is added to the first composition at an amount of 1% (v/v), and is present in the second composition at an amount of 0.8%.

7. The method of claim 1, wherein the cryoprotectant is human serum albumin or Ficoll 400.

8. The method of claim 1, wherein the cryoprotectant is Ficoll 400.

9. A method of preparing freeze-dried platelets, said method comprising:
providing platelets,
suspending the platelets in a salt buffer that comprises 100 mM trehalose and 1% (v/v) ethanol to make a first composition,
incubating the first composition at 37° C. for 2 hours,
adding Ficoll 400 to a final concentration of 6% (w/v) to make a second composition,
lyophilizing the second composition to make freeze-dried platelets, and
heating the freeze-dried platelets at 80° C. for 24 hours.

10. Freeze-dried platelets made by a method comprising:
providing platelets,
suspending the platelets in a salt buffer that comprises at least one saccharide to make a first composition,
incubating the first composition at a temperature above freezing for at least a sufficient time for the at least one saccharide to come into contact with the platelets,
adding a cryoprotectant to make a second composition,
wherein the first composition is not subjected to centrifugation or other separation procedure before the cryoprotectant is added, and
lyophilizing the second composition to make freeze-dried platelets.

11. The freeze-dried platelets of claim 10, wherein the platelets are stable at room temperature for at least six months.

12. Rehydrated freeze-dried platelets having a size and granularity essentially identical to fresh platelets.

13. The rehydrated platelets of claim 12, wherein the platelets are present in a composition that further comprises Ficoll 400.

14. The rehydrated platelets of claim 12, wherein the platelets are not activated.

15. A kit comprising freeze-dried platelets, wherein said platelets are produced by a method comprising:
providing platelets,
suspending the platelets in a salt buffer that comprises at least one saccharide to make a first composition,
incubating the first composition at a temperature above freezing for at least a sufficient time for the at least one saccharide to come into contact with the platelets,
adding a cryoprotectant to make a second composition,
wherein the first composition is not subjected to centrifugation or other separation procedure before the cryoprotectant is added, and
lyophilizing the second composition to make freeze-dried platelets.

16. The kit of claim 15, wherein the kit comprises more than one container containing the freeze-dried platelets.

17. The kit of claim 15, wherein the kit is a container containing an amount of freeze-dried platelets equivalent to the amount of platelets in one liter or one pint of blood.

18. The kit of claim 15, wherein the kit comprises human freeze-dried platelets.

19. The kit of claim 15, wherein the kit comprises one or more containers, each containing 1×10⁸ to 1×10⁹ platelets.

20. The kit of claim 15, wherein the kit comprises one or more bandages for topical contact of a wound comprising the platelets, wherein the bandage comprises 1×10⁸ to 1×10⁹ platelets per cm³ of surface area of the portion of the bandage intended for contact with the wound.
